(19) United States
(12) Patent Application Publication
(10) Pub. No.: US 2026/0176490 A1
(43) Pub. Date: Jun. 25, 2026

(54) SPRAYABLE, PAINTABLE, AND EXTRUDABLE HYDROPHILIC SEALANTS

(71) Applicant: Concrete Sealants, Inc., Tipp City, OH (US)

(72) Inventors: Van R. Foster, Tipp City, OH (US); Austin Boise, Tipp City, OH (US); Dakota Burke, Tipp City, OH (US); Howard Wingert, Tipp City, OH (US)

(21) Appl. No.: 18/991,989

(22) Filed: Dec. 23, 2024

(51) Int. Cl. C09D 133/02; C09D 7/40; C09D 7/61; C09D 7/63

(52) U.S. Cl. CPC C09D 133/02; C09D 7/61; C09D 7/63; C09D 7/70

(57) ABSTRACT

A sealant comprising at least one hydrophilic superabsorber, wherein the at least one hydrophilic superabsorber includes a hydrophilic polymer; at least one elastomeric polymer, wherein the at least one elastomeric polymer includes a silyl modified polymer; and at least one abrasive material configured to abrade the hydrophilic superabsorber.

### BACKGROUND

The disclosed technology relates in general to a sealants for use in industrial and commercial applications, and more specifically to a hydrophilic material used for sealing gaps and voids found in a variety of concrete structures. The disclosed sealing material may be formulated as a spray, a paint, a caulk, or other flexible and malleable material.

In the field of concrete construction, the term “hydrophilic waterstop” refers to a known materials technology that is typically used to prevent water from infiltrating certain concrete structures. Example concrete structures include below-grade structures such as parking garages, tunnels, stores, and subterranean warehouses. Hydrophilic waterstops are also used to prevent water intrusion into construction joints formed in below ground structures that are subjected to medium to low water pressure such as precast tunnel segments, cast-in-place construction joints, and foundations. Additionally, hydrophilic waterstops may be used in connecting joints in diaphragm walls, in cable ducts, and for preventing water ingress into pipe and steel work penetrations through walls and floors. If water ingress in construction joints is not prevented, corrected, or otherwise addressed, a variety of problems may occur, including expansion cracks, rebar corrosion and mold infiltration. Expansion cracks can result in structural fatigue and damage associated with freeze-thaw cycling. Damage to reinforcing steel rebars can weaken a structure and voids in a structure may allow for penetration of stagnant water and the formation of fungus, mold, or other microbiological films and contaminants.

The term “hydrophilic” refers to the ability of a material to swell when the material comes into contact with water. Hydrophilic waterstops expand in the direction of surrounding concrete when water contacts the material, thereby forming a watertight seal in concrete joints, voids, and gaps. Use of expandable waterstops to fill such voids prevents water ingress and reduces or eliminates problems such as those discussed above, thereby improving the longevity and stability of concrete structures. Commercially available hydrophilic waterstop sealants include preformed (profile) sealants and cartridge (extrudable) sealants. Some preformed sealants are formulated to be malleable when applied to a joint, but may not be capable of withstanding multiple water absorption cycles while still maintaining shape and material integrity. Other preformed sealants are formulated to provide a firmer, more durable sealant, but lack moldability. Cartridge (extrudable) sealants provide ease of dispensability and can be applied to fill irregular voids, but may require unacceptably long cure times. Paintable (low viscosity) products provide a thinner film that can be easily applied and that cures more quickly than extrudable products; however, existing products of this nature may not exhibit the necessary expansion characteristics. Accordingly, there is an ongoing need for a sprayable or paintable hydrophilic waterstop that provides acceptable expandability and that maintains structural integrity after exposure to water and subsequently drying.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One embodiment of the disclosed technology provides a first example material configured as a sealant, or for use as a sealant, comprising a hydrophilic superabsorber; an elastomeric polymer; and an abrasive configured to abrade the hydrophilic superabsorber. In certain implementations, the hydrophilic superabsorber is a hydrophilic polymer, which may be a crosslinked sodium polyacrylate polymer. In certain implementations, the elastomeric polymer is a silyl modified polymer. In certain implementations, the abrasive includes ceramic microspheres. In certain implementations, the sealant is formulated as a spray and has a viscosity of 50,000-60,000 centipoise (cps). In other implementations, the sealant is formulated as a paint and has a viscosity of 50,000-60,000 cps. In still other implementations, the sealant is formulated as a caulk and has a viscosity of 500,000-800,000 cps. Certain implementations of the sealant further comprise a plasticizer, a defoamer, a moisture scavenger, calcium carbonate, an ultraviolet (UV) stabilizer, an antioxidant, a curing catalyst, and an adhesion promoter. Certain implementations of the sealant further comprise fumed silica, silane, and a colorant.

Another embodiment of the disclosed technology provides a second example material configured as a sealant, or for use as a sealant, comprising at least one hydrophilic superabsorber, wherein the at least one hydrophilic superabsorber includes a hydrophilic polymer; at least one elastomeric polymer, wherein the at least one elastomeric polymer includes a silyl modified polymer; and at least one abrasive configured to abrade the hydrophilic superabsorber. In certain implementations, hydrophilic polymer is a crosslinked sodium polyacrylate polymer. In certain implementations, the abrasive includes ceramic microspheres. In certain implementations, the sealant is formulated as a spray and has a viscosity of 50,000-60,000 cps; or the sealant is formulated as a paint and has a viscosity 50,000-60,000 cps; or the sealant is formulated as a caulk and has a viscosity of 500,000-800,000 cps. Certain implementations of the sealant further comprises at least one plasticizer, at least one defoamer, at least one moisture scavenger, calcium carbonate, at least one ultraviolet (UV) stabilizer, at least one antioxidant, at least one curing catalyst, at least one adhesion promoter, fumed silica, silane, at least one colorant, or combinations thereof.

Still another embodiment of the disclosed technology provides a third example material configured as a sealant, or for use as sealant, comprising at least one hydrophilic superabsorber, wherein the at least one hydrophilic superabsorber includes a hydrophilic polymer, and wherein the hydrophilic polymer is a crosslinked sodium polyacrylate polymer; at least one elastomeric polymer, wherein the at least one elastomeric polymer includes a silyl modified polymer; and at least one abrasive configured to abrade the hydrophilic superabsorber, wherein the abrasive includes ceramic microspheres. In certain implementations, the sealant is formulated as a spray and has a viscosity of 50,000-60,000 cps; or the sealant is formulated as a paint and has a viscosity of 50,000-60,000 cps; or the sealant is formulated as a caulk and has a viscosity 500,000-800,000 cps. Certain implementations of the sealant further comprise at least one plasticizer, at least one defoamer, at least one moisture scavenger, calcium carbonate, at least one ultraviolet (UV) stabilizer, at least one antioxidant, at least one curing catalyst, at least one adhesion promoter, fumed silica, silane, at least one colorant, or combinations thereof.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### DETAILED DESCRIPTION

Example implementations are described below. Although the following detailed description contains many specifics for the purposes of illustration, a person of ordinary skill in the art will appreciate that many variations and alterations to the following details are within the scope of the disclosed technology. Accordingly, the following example implementations are set forth without any loss of generality to, and without imposing limitations upon, the claimed subject matter.

The various embodiments and implementations disclosed and discussed herein are examples only and are provided to assist in the explanation of the apparatuses, devices, systems, and methods described herein. None of the features or components shown in the drawings or discussed below should be taken as required for any specific implementation of any of these apparatuses, devices, systems or methods unless specifically designated as such. For ease of reading and clarity, certain components, modules, or methods may be described solely in connection with a specific FIGURE. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The disclosed technology includes a hydrophilic sealant that provides enhanced swelling properties when applied to voids or gaps between objects or substrates. This sealant absorbs water that is present in the environment in which the sealant is located and swells in size to block water passage or intrusion into the void or gap. The sealant then returns to its original size when it has dried. In various implementations, the disclosed sealant is formulated to be either sprayed on a surface or painted on a surface. Other easily-dispensed formulations such as, for example, putty or caulk, are possible.

One example implementation of the disclosed technology provides a sealant formula that contains both a superabsorber (e.g., superabsorbent polymer) and an elastomeric polymer. These ingredients allow the sealant to swell and retain its shape and structural integrity rather than disintegrating upon swelling and then subsequently shrinking. The disclosed sealant formula also contains an abrasive or abrasive material that abrades the surface of the superabsorber during high-shear mixing, thereby creating a greater surface area that increases the swelling capability of the formula.

Superabsorbent polymers are water-absorbing hydrophilic homopolymers or copolymers that absorbs and retains large amounts of a liquid relative to its own mass. Crosslinked (network) sodium polyacrylate polymers respond in this manner to water, which is absorbed osmotically by this material. This superabsorbent polymer absorbs 100 to 1000 times its mass in water. When this sodium containing polymer contacts water, the sodium tends to distribute equally between the network and the water. Some sodium atoms leave the network and move into the water, and when sodium atoms leave, they are replaced with water molecules. The water molecules swell the polymer network to keep the sodium concentration balanced between the polymer and the water. Crosslinks connecting the polymer chains together prevent the chains from dissolving or breaking apart in the water. One example of a suitable elastomeric polymer is silyl modified polymer (SMP), which consists of a polymer backbone terminated by silyl or silane groups. Silyl modified polymers exhibit effective adhesion on a wide range of substrate materials, and exhibit acceptable temperature and UV resistance. To generate improved reactivity with faster and more effective absorption, an abrasive media is included in the finished sealant formula to grind and open up the surface area of the superabsorbers contained in the sealant formula. One example of a suitable abrasive material are ceramic microspheres. The disclosed sealant and the method by which it is made improves the swelling properties of the finished sealant (film). Films cast at 0.05 inches can absorb between 150-200% (by weight) in distilled water after 24 hours. The method results in minimal loading in the formula which would otherwise weaken thinly applied films. Lower loading also provides a lower raw material cost.

In one example implementation, a silyl modified polymer (SMP) was included in the sealant formulation due to its elastic properties and its ability to recover without deformation when exposed to water. Table 1, below, lists a first example sealant formulation, in accordance with the disclosed technology, and provides functional ranges for the various ingredients in the formulation.

TABLE 1
Example Hydrophilic Sealant

| | | | % by |
|---|---|---|---|
| Ingredient | Manufacturer | Category | weight |
| SMP polymer | Wacker, Covestro | polymer | 10.00-75.00 |
| | Evonik, Kaneka | | |
| Plasticizer | Emerald Kalama, | plasticizer | 10.00-75.00 |
| | Eastman, BASF | | |
| Defoamer | BYK, ESP, Inc. | defoamer | 0.10-1.00 |
| VTMO, VTEO | Wacker, | moisture | 1.00-6.00 |
| | RoyalSil, | scavenger | |
| | Momentive | | |
| Precipitated | Specialty | calcium carbonate | 10.00-50.00 |
| CaCO₃ | Minerals | | |
| Ground CaCO₃ | Huber, Omya | calcium carbonate | 10.00-60.00 |
| Treated fumed | Evonik, Wacker | fumed silica | 1.00-5.00 |
| silica | | | |
| Colorant | Lanxess, Akrochem | color pigment | 0.01-10.00 |
| Superabsorber | Chase, Inc. | water absorber | 1.00-15.00 |
| Abrasive | Sphere One | ceramic | 1.00-10.00 |
| medium | | microsphere | |
| UV-stabilizer | Clariant, BASF | UV stabilizer | 0.10-5.00 |
| | | package | |
| Antioxidant | Clariant, BASF | antioxidant | 0.10-5.00 |
| DAMO | Wacker, RoyalSil, | adhesion promoter | 0.10-2.30 |
| | Momentive | | |
| DBTL | Galata Chemical, | curing catalyst | 0.05-2.00 |
| | Gulbrandson | | |
| Coatosil T | Momentive | adhesion promoter | 0.01-2.00 |
| | | | 100.00 |

In another example implementation, the disclosed sealant is formulated to exhibit increased (high) viscosity ranging from 500,000-800,000 cps. This implementation of the formulation may be applied from a container such as a pail or may be extruded from a cartridge of sausage container. Table 2, below, lists a second example sealant formulation, in accordance with the disclosed technology.

TABLE 2
Example High Viscosity Hydrophilic Sealant (VF-03-057)

| | | | % by |
|---|---|---|---|
| Ingredient | Manufacturer | Category | weight |
| STP-35 | Wacker | polymer | 19.46 |
| Kalama K975 | Emerald Kalama | plasticizer | 34.05 |
| BYK 1790 | BYK | defoamer | 0.20 |
| VTMO | RoyalSil | moisture scavenger | 2.48 |
| Ultrapflex 100 | Specialty Minerals | calcium carbonate | 17.90 |
| Hubercarb Q3T | Superior Materials | calcium carbonate | 14.25 |
| Akrochem E773 | Akrochem | blue colorant | 0.20 |
| Blue | | | |
| HDK H18 | Wacker | fumed silica | 1.88 |
| SA 2G-110 | Chase, Inc. | superabsorber | 6.63 |
| Extendosphere | Sphere One | ceramic microsphere | 1.73 |
| TG | | | |
| IBC-760 | Clariant | UV stabilizer | 0.61 |
| Hostanox O3P | Clariant | antioxidant | 0.74 |
| DAMO | RoyalSil | silane | 0.613 |
| DBTL | Galata Chemical | curing catalyst | 0.20 |
| Coatosil T | Momentive | adhesion promoter | 0.05 |
| | | | 100.00 |

For applications involving a larger gap between substrates or components, a sealant formulation exhibiting higher viscosity and enhanced hydrophilic properties is desirable. Such sealants can be applied using a caulking gun or other dispensing device. As the data shown below in Table 3 demonstrates, the thicker sealants disclosed herein provide enhanced recovery when subjected to rigorous cycle testing. The formulation shown in Table 3 exhibited almost 100% recovery after 5 test cycles. When subjected to a cycle test of ten days of exposure (with an expansion measurement after 1 and 10 days) followed by a drying period of 5 days, recovery to an original shape was observed after the sealant material was dried. A total of 5 test cycles were measured without any recorded failure of the tested material.

TABLE 3
Recovery Properties for CS-1900 Cycle Testing in DI Water

| Total Hours | Wet/Dry Days | % Expansion (VF-03-057) |
|---|---|---|
| 24 Hours | 1 Day Wet | 92 |
| 216 Hours | 9 Days Wet | 200 |
| 120 Hours | 5 Days Dry | 0 |
| 24 Hours | 1 Day Wet | 100 |
| 216 Hours | 9 Days Wet | 225 |
| 120 Hours | 5 Days Dry | 33 |
| 24 Hours | 1 Day Wet | 133 |
| 216 Hours | 9 Days Wet | 225 |
| 120 Hours | 5 Days Dry | 0 |
| 24 Hours | 1 Day Wet | 142 |
| 216 Hours | 9 Days Wet | 200 |
| 120 Hours | 5 Days Dry | 0 |
| 24 Hours | 1 Day Wet | 142 |
| 216 Hours | 9 Days Wet | 217 |
| 120 Hours | 5 Days Dry | 0 |

As illustrated by the data presented in Table 4, below, formulations of greater thickness or greater viscosity exhibited superior integrity when continuously exposed to water. Comparison samples 1 and 2, which are based on polyurethane polymers lost integrity after 49 days, while disclosed formula VF-03-057 remained intact and did not exhibit degradation over time.

TABLE 4
Durability Properties as a Function of Submersion in Water

| Days of | Comparison | Comparison | VF-03-057 |
|---|---|---|---|
| Submersion | Sample 1* | Sample 2* | (SMP formula)* |
| 1 | 100 | 112 | 100 |
| 2 | 140 | 238 | 132 |
| 7 | 140 | 495 | 144 |
| 14 | 140 | 796 | 216 |
| 21 | 140 | 987 | 240 |
| 28 | 140 | 1125 | 263 |
| 42 | 130 | 900 | 308 |
| 49 | dissolved | dissolved | 316 |

*(% expansion)

In another example implementation, the disclosed sealant is formulated to exhibit decreased (low) viscosity of 50,000-60,000 cps. This implementation of the formulation may be sprayed using appropriate spraying equipment or may be applied to a surface using a brush or a roller. Table 5, below, lists a third example sealant formulation in accordance with the disclosed technology.

TABLE 5
Example Low Viscosity Hydrophilic Sealant (VF-07-012)

| | | | % by |
|---|---|---|---|
| Ingredient | Manufacturer | Category | weight |
| STP-35 | Wacker | polymer | 14.15 |
| SM-20 | Wacker | polymer | 4.07 |
| K975 | Emerald Kalama | plasticizer | 38.55 |
| BYK 1790 | BYK | defoamer | 0.25 |
| VTMO | RoyalSil | moisture scavenger | 1.50 |
| Omyacarb 520FL | Omya | calcium carbonate | 30.81 |
| Bayferrox 318NM | Lanxess | black colorant | 0.10 |
| SA 2G-110 | Chase, Inc. | superabsorber | 6.63 |
| Extendosphere TG | Sphere One | ceramic microsphere | 1.73 |
| IBC-760 | Clariant | UV stabilizer | 0.61 |
| Hostanox O3P | Clariant | antioxidant | 0.74 |
| DAMO | RoyalSil | silane | 0.61 |
| DBTL | Galata Chemical | curing catalyst | 0.20 |
| Coatosil T | Momentive | adhesion promoter | 0.05 |
| | | | 100.00 |

The following example method for formulating the disclosed sealants ensures proper abrading of the superabsorbers. The polymers, plasticizer, and defoaming chemical are added to a mixing vessel capable of pulling vacuum while maintaining batch temperature to a predetermined temperature. A moisture scavenger is then added to chemically remove any water introduced into the production batch after fillers such as calcium carbonate and any desired colorants are added. Fumed silica may be added at this time as well. Surface treated fumed silica may be used for minimizing water attached to the surface of the sealant material that would reduce package stability of the final product.

After sufficiently mixing the raw materials into a homogeneous mixture, the superabsorbers and ceramic microspheres are added and mixed for a total of 10-60 minutes to abrade the surface of the superabsorbers. Surface abrasion expands the surface area of the superabsorbers, thereby increasing reactivity. UV stabilizers and antioxidants are added to the mixture and DAMO (a metal-based catalyst) and an adhesion promotor (e.g., Coatosil T), are added to the mixture. The product is then mixed under vacuum to remove any entrained air, while maintaining internal temperature under 110° F. to prevent flashing off the moisture scavenger or otherwise damaging the polymer.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A material, comprising:
(a) a hydrophilic superabsorber;
(b) elastomeric polymer; and
(c) an abrasive configured to abrade the hydrophilic superabsorber, and
(d) wherein the material is configured as a sealant.

2. The material of claim 1, wherein the hydrophilic superabsorber is a hydrophilic polymer.

3. The material of claim 2, wherein the hydrophilic polymer is a crosslinked sodium polyacrylate polymer.

4. The material of claim 1, wherein the elastomeric polymer is a silyl modified polymer.

5. The material of claim 1, wherein the abrasive includes ceramic microspheres.

6. The material of claim 1, wherein the sealant is formulated as a spray and has a viscosity of 50,000-60,000 cps.

7. The material of claim 1, wherein the sealant is formulated as a paint and has a viscosity of 50,000-60,000 cps.

8. The material of claim 1, wherein the sealant is formulated as a caulk and has a viscosity of 500,000-800,000 cps.

9. The material of claim 1, further comprising a plasticizer, a defoamer, a moisture scavenger, calcium carbonate, an ultraviolet (UV) stabilizer, an antioxidant, a curing catalyst, and an adhesion promoter.

10. The material of claim 1, further comprising fumed silica.

11. The material of claim 1, further comprising silane.

12. The material of claim 1, further comprising a colorant.

13. A material, comprising:
(a) at least one hydrophilic superabsorber, wherein the at least one hydrophilic superabsorber includes a hydrophilic polymer;
(b) at least one elastomeric polymer, wherein the at least one elastomeric polymer includes a silyl modified polymer; and
(c) at least one abrasive configured to abrade the hydrophilic superabsorber, and
(d) wherein the material is configured as a sealant.

14. The material of claim 13, wherein the hydrophilic polymer is a crosslinked sodium polyacrylate polymer.

15. The material of claim 13, wherein the abrasive material includes ceramic microspheres.

16. The material of claim 13, wherein the sealant is formulated as a spray and has a viscosity of 50,000-60,000 cps; or wherein the sealant is formulated as a paint and has a viscosity of 50,000-60,000 cps; or wherein the sealant is formulated as a caulk and has a viscosity of 500,000-800,000 cps.

17. The material of claim 13, further comprising at least one plasticizer, at least one defoamer, at least one moisture scavenger, calcium carbonate, at least one ultraviolet (UV) stabilizer, at least one antioxidant, at least one curing catalyst, at least one adhesion promoter, fumed silica, silane, at least one colorant, or combinations thereof.

18. A material, comprising:
(a) at least one hydrophilic superabsorber, wherein the at least one hydrophilic superabsorber includes a hydrophilic polymer, and wherein the hydrophilic polymer is a crosslinked sodium polyacrylate polymer;
(b) at least one elastomeric polymer, wherein the at least one elastomeric polymer includes a silyl modified polymer; and
(c) at least one abrasive configured to abrade the hydrophilic superabsorber, wherein the abrasive includes ceramic microspheres, and
(d) wherein the material is configured as a sealant.

19. The material of claim 18, wherein the sealant is formulated as a spray and has a viscosity of 50,000-60,000 cps; or wherein the sealant is formulated as a paint and has a viscosity of 50,000-60,000 cps; or wherein the sealant is formulated as a caulk and has a viscosity of 500,000-800,000 cps.

20. The material of claim 18, further comprising at least one plasticizer, at least one defoamer, at least one moisture scavenger, calcium carbonate, at least one ultraviolet (UV) stabilizer, at least one antioxidant, at least one curing catalyst, at least one adhesion promoter, fumed silica, silane, at least one colorant, or combinations thereof.
